(19) United States
(12) Patent Application Publication
(10) Pub. No.: US 2006/0181063 A1
(43) Pub. Date: Aug. 17, 2006

(54) Sliding goose neck trailer with sliding load bars

(76) Inventor: William Lester Eddings, Jefferson, OR (US)

Correspondence Address: William Lester Eddings, P.O. Box 73, Jefferson, OR, 97352, US

(21) Appl. No.: 11/347,756

(22) Filed: Feb. 6, 2006

Related U.S. Application Data
(60) Provisional application No. 60/593,844, filed on Feb. 17, 2005.

(51) Int. Cl. B62D 33/08; B60P 3/34

(52) U.S. Cl. 280/656; 280/149.2; 296/26.09

(57) ABSTRACT

To provide a trailer 20,000 lbs or less that has a ten foot stretch to accommodate different lengths of light cargo. This design is for a Goose neck, fifth wheel or a pull trailer and could be built to stretch longer than 10 feet. The sliding load bars are to accommodate a tie-down winch and hook on either side.

### DRAWING DESCRIPTION

FIG. 1: Three-dimensional view of partially opened trailer.

FIG. 2: Orthographic detail cutaway view of siding load bar.

FIG. 3: Orthographic detail of Channeled Frame/I-Beam Frame hole configuration.

FIG. 4: Three-dimensional detail cutaway view of sliding assembly.

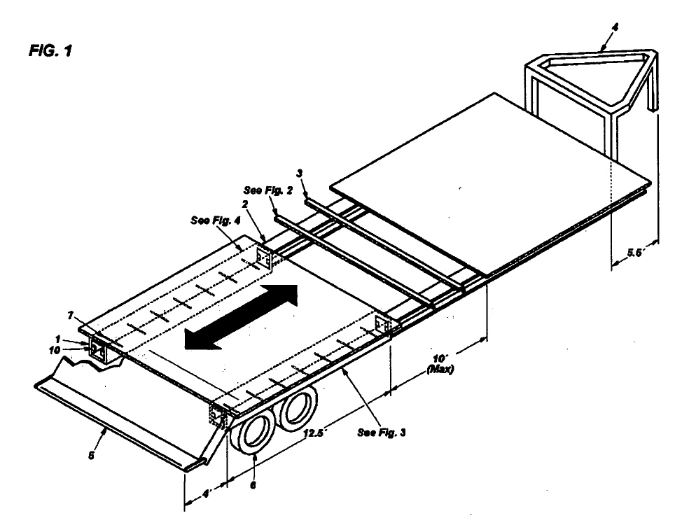

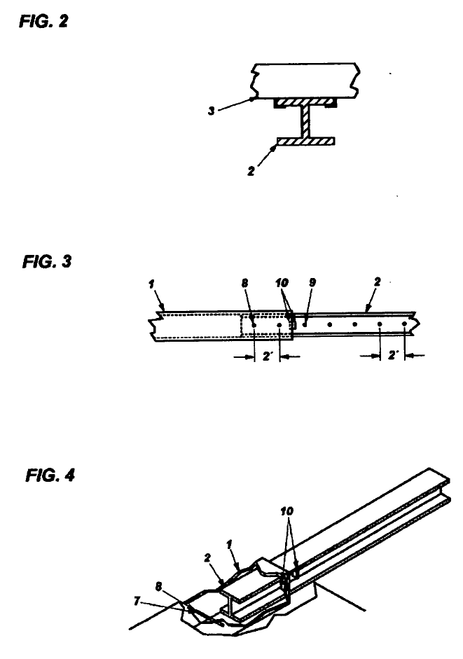

### NUMBER DESCRIPTION LIST

1: Channeld Tubing Frame
2: I-Beam Frame
3: Sliding Load Bar
4: Goose-Neck
5: Beaver-Tail
6: 17 Wheels with 8 lugs
7: 7 each (per side), 1.25″ Pins, spaced 2′ apart, penetrating channel through both sides
8: 2 each (per side), 1.25″ Pin Holes, spaced 2′ apart
9: 7 each (per side), holes, spaced 2′ apart
10: 12 each, Stops, welded to I-Beam and Channel Frames

NOTE: The trailer will always be pinned by 2 pins on each side, while travelling for a total of 4 pins.

What is claimed is:

1. A trailer that stretches out up to ten feet on 2 foot pin settings and then is able to retract back to original length with 2 sliding load bars.
